(19) United States
(12) Patent Application Publication
(10) Pub. No.: US 2021/0002801 A1
(43) Pub. Date: Jan. 7, 2021

(54) IRREGULARLY SHAPED POLYMER FIBERS

(71) Applicant: Carl Freudenberg KG, Weinheim (DE)

(72) Inventors: Shih Wen Tseng, Taoyuan (TW); Michael Hess, Trippstadt (DE); Volker Roehring, Weinheim (DE); Hsien Fang Chiou, Taoyuan (TW); Wie Ren Huang, Taoyuan (TW); Huan Hsiang Lin, Taoyuan (TW)

(21) Appl. No.: 16/916,156

(22) Filed: Jun. 30, 2020

(30) Foreign Application Priority Data
Jul. 2, 2019 (EP) 19 183 845.7

(51) Int. Cl. D04H 1/4391; D01D 5/253; D06N 7/00; D01D 5/098; D01D 5/06; D04H 1/435; B01D 39/16

(52) U.S. Cl. CPC D04H 1/43912; D01D 5/253; D06N 7/0076; D06N 2213/06; D01D 5/06; D04H 1/435; B01D 39/1623; D01D 5/098

(57) ABSTRACT

A solid polymeric fiber includes: a six- to ten-fingered sectional area having fingers having central axes. The fingers are positioned unsymmetrically to each of the central axes, and/or the sectional area of the fiber has no rotational axis. In an embodiment, the six- to ten-fingered sectional area is a six-fingered sectional area.

### CROSS-REFERENCE TO PRIOR APPLICATION

Priority is claimed to European Patent Application No. EP 19 183 845.7, filed on Jul. 2, 2019, the entire disclosure of which is hereby incorporated by reference herein.

### FIELD

The present invention relates to a polymeric fiber of irregular shape, comprising an at least six-fingered sectional area, a filter comprising the polymeric fiber, a nonwoven fabric comprising the polymeric fiber, the use of the polymeric fiber and a spinneret designed to provide said polymeric fibers.

### BACKGROUND

Polymeric fibers are obtained by various known spinning processes. Fibers from polymers that become flowable and pliable under heating, in particular thermoplastics, can be produced by melt spinning processes. Melt spinning is a specialized form of extrusion, wherein a polymeric material is melted in order to obtain a polymer melt which is then passed through a spinneret, i.e. a type of die used to form continuous filaments. In a usual embodiment, the spinneret comprises a metal plate with an arrangement (pattern) of small holes through which the polymer melt is passed into the air or a liquid for solidification and fiber formation. The design of the spinneret varies greatly. Conventional spinneret orifices are circular and produce fibers that are round in cross section. Capillary spinneret orifices enable extrusion of filaments with small diameters of one denier or less. The extruded molten filaments exiting the spinneret are cooled to obtain the final fibers which have the shape of the outlet openings of the spinneret plate. It is known to use spinneret orifices having shaped holes to obtain fibers of different shapes and with various characteristics.

Different shapes of fibers and in particular multi-lobal fibers have been known for many years. The known fibers can be of a triangular cross section, so called trilobal fibers. The fibres can also be of a square shape or can be a star shaped fiber with four, five, six or more fingers. Furthermore, fibers showing flat oval, T-shape, M-shape, S-shape, Y-shape, or H-shape cross sections are known.

The single fibers (filaments) can be spun to yarns, and a number of yarns can be plied together for producing threads.

One special aspect is the use of polymer fibers for the manufacture of filters for various applications. Today, filters are used on a large scale for a variety of purposes. Thus, in the automotive area filters are used e.g. as cabin air filters to protect the vehicle occupants from pollen, soot, fine dust, allergens, gases, etc. Engine intake air filters remove contaminants that may have a negative impact on the combustion process and the sensor systems of the cars. In fuel cell vehicles there is a demand for special intake air filters and humidifiers. In the various sectors of industry, filters are employed inter alia in gas turbines and compressors, in the food and beverage industry, for air pollution control, for corrosion control, for cleanrooms and pharmaceutical production. Filter further find use in hospitals and medical facilities. In everyday life, filters are used e.g. in vacuum cleaners as filters for bagless vacuum cleaners, for odor removal, as motor protection filters and for the exhaust air. Filters can be employed in many different forms, e.g. filter mats, comprising thermally bonded nonwovens made of polymeric fibers.

Another special aspect is the use of polymer fibers for the manufacture of carpets. Tufted carpets are multilayer, pile textiles. They are manufactured on special machines on which the pile yarn is joined but not tied, by means of needles, with a base layer, which in the case of carpets today consists almost exclusively of synthetic fibers. The anchoring of the pile yarn is accomplished by a subsequent coating of the reverse side of the base layer with natural or synthetic rubber or with polyvinyl chloride (PVC). The rubber coating moreover is joined to a so-called secondary backing, which as a rule consists of an elastomer foam or a woven or non-woven textile material.

Tufted products find many uses, for example, as carpets, runners, textile tiles, bedspreads, bath mats, etc. In their production, the base layer in particular is of considerable importance. The task of the base layer is a safe anchoring of the pile yarn.

The term “tufting” refers to a technology for the production of three-dimensional textile sheets. It is the process most frequently employed worldwide for preparing carpets. Tufting works on the principle of a sewing machine. Needles insert the so-called pile yarn into a base material (woven or non-woven fabric), the so-called primary backing or support. The needles stitch through the base material; before the needles are running back again, the inserted pile yarn is held by loopers. This produces loops (pile knots) on the top side of the tufting fabric. In this way, a so-called loop-pile carpet is obtained. If the loops are cut open with a knife, a velour carpet (cut-pile carpet) is formed. Frequently, the knife is already attached to the looper, so that the holding and cutting of the pile is done in one operation. In order to hold the stitched pile yarn tight, a secondary backing or latex layer must be applied. This process is referred to as lamination or integration.

EP 1619283 describes a method for producing a tufted nonwoven fabric, wherein fibers which are divergent from a round fiber cross section are used for tuft backing.

U.S. Pat. No. 3,351,205 describes twisted strands for nonwoven fibers. This document discloses that 6-finger filaments (star-shaped configuration in a radial cross-section having six oppositely disposed lobes) are useful for twisted strands (see FIG. 32). The 6-finger filaments are regular, and every finger has the same width and the same distance from the centre.

U.S. Pat. No. 5,069,970 describes polyester based fibers comprising polyolefins. The fibers have different shapes, e.g. star-shape and have 6-fingers (FIG. 3). However, the shapes of those fibers are regular, too.

U.S. Pat. No. 6,787,227 describes filaments having at least five vertices. The cross-section of the filaments is preferably star-shaped. However, also these filaments have a regular shape.

WO 2017/006234 discloses polyester fibers having a gear-shaped cross-section which seems to be regular.

EP 3069625 relates to filaments for artificial hair. The fiber has a multi-lobal shape having three or more interlobe gap regions. An irregular 6-finger shape filament is not described.

EP 1966416 describes a 6-finger filament with three major and three minor lobes. However, the major lobes have the same width and length, and the minor lobes have also the same width and length, i.e. they are regular.

WO 2006/133036 describes mixtures of various shaped fibers to provide controllable improvements in opacity, barrier properties, and mechanical properties. The variety of cross sections include solid round fibers, hollow round fibers, multi-lobal solid fibers, hollow multi-lobal fibers, crescent shaped fibers, square shaped fibers, and any combination thereof

US 2017/0226673 describes a modified cross-section hollow fiber, wherein the fiber comprises a hollow part, a shape maintaining part and a volume control part. The hollow ratio of the hollow part is from 15 to 30% in the fiber cross-sectional area. Furthermore, the fibers are produced in a mono-filament/mono-fiber spinning process.

US 2013/0133980 describes a winged fiber, which includes a core surrounded by a plurality (16 to 32) of lobes. The fiber is prepared by co-extruding the desired fiber material inside another polymer, which is washed away, after the end fiber is completely formed. However, the fiber itself is produced in a mono-filament/mono-fiber spinning process.

There is a need for fibers whose property profile can be adapted individually. A special need e.g. exists for fibers that are suitable for the manufacture of nonwovens that can be used as multi purpose filtration substrate. Thus, the fibers and the resulting nonwovens should e.g. be suitable for the production of air permeable filters, suitable for high throughput, low pressure drop applications. Currently, there can be seen a demand for fibers which have lighter weight and/or fibers which have a larger fiber diameter for low pressure drop applications. In any case, the maintenance of excellent filtration performance is desired. Therefore, one task is the development of fibers having high fiber diameter and larger surface area in order to meet the requested low pressure drop requirement with at the same time improved particle capture performance. Another demand for fiber production are spinnerets with orifices that allow spinning at least two different polymers in order to form a desired design of the different fiber in one spinnerets and to form the fabric in different layers in one step. It should be possible to form the target shape of the fiber in one step spinning process and thermal-bonding the web directly.

### SUMMARY

In an embodiment, the present invention provides a solid polymeric fiber, comprising: a six- to ten-fingered sectional area comprises fingers having central axes, wherein the fingers are positioned unsymmetrically to each of the central axes, and/or wherein the sectional area of the fiber has no rotational axis.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a six-fingered polymeric fiber according to the invention.

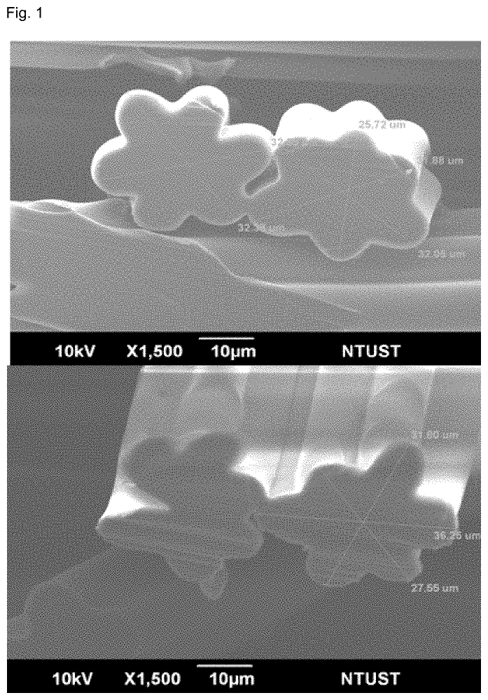

FIG. 2 illustrates a detail view of six slots of a spinneret forming the polymeric fiber according to the invention.

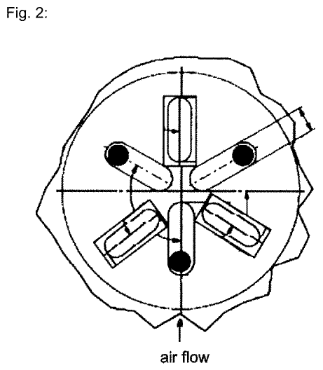

### DETAILED DESCRIPTION

In an embodiment, the present invention provides new fibers or new compositions of fibers that allow for the manufacture of nonwovens with good application properties, in particular for filter application. In particular, it is an object of the invention to provide optimized fibers having both a larger surface area and high fiber diameter in order to provide fibers for high filtration performance. Further, it is an object of the invention to provide a process, which allows spinning at least two different polymers in order to form the desired design of the fibers in one spinneret and to form a fabric with different layers in one step.

The problem underlying the invention is solved by the polymeric fibers according to the invention comprising an at least six-fingered sectional area.

The polymeric fibers according to the invention have at least one of the following advantages:

Due to the larger surface the particle holding capacity of filters based on these fibers is increased.

Due to the larger fiber diameter the pressure drop of filters based on these fibers is reduced.

Due to the high surface area of the fibers the dirt holding capacity of filters and wiping mops based on these fibers is high.

The high stiffness results in a higher durability.

With filters on the basis of said fibers a high permeability and depth filtration are possible which results in efficiency sustained cleaning of air passed through the filters with low pressure drop.

It is possible to spin fibers, which differ in the polymer material, in one spinneret and form a multi-density layer in one step.

The invention relates to a polymeric fiber comprising an at least six-fingered sectional area, having at least one of the following properties:

the fingers are positioned unsymmetrically to each of the central axes,

the sectional area of the fiber has no rotational axis.

In particular, the invention relates to a solid polymeric fiber comprising a six- to ten-fingered sectional area, having at least one of the following properties:

the fingers are positioned unsymmetrically to each of the central axes,

the sectional area of the fiber has no rotational axis.

The invention also relates to a nonwoven fabric comprising the polymeric fiber as defined above and below.

The invention also relates to a filter material comprising the polymeric fiber as defined above and below.

The invention also relates to the use of the polymeric fiber as defined above and below for the preparation of nonwoven fabrics.

The invention also relates to a spinneret comprising capillary spinneret orifices comprising a pattern of arranged holes designed to provide polymeric fibers as defined above and below.

In the sense of the invention the term “inner circle rᵢ” is the maximum circle that fits completely in the cross sectional area of the fiber.

In the sense of the invention the term “outer circle rₒ” is the minimum circle that completely surrounds the cross sectional area of the fiber.

The term “length” of each finger is the distance from the finger tip to the center of the inner circle

The term “fiber” denotes an elongated body, wherein the length dimension is greater than the transverse dimension of width and thickness. Thus, the term “fiber” is synonymously used for filament.

The term “solid fiber” denotes a fiber, which does not comprise any hollow parts in the cross sectional area of the fiber.

### FIBERS

The polymeric fibers according to the invention generally have an irregular shape of the sectional area. Generally, the sectional area of the fiber has no rotational axis. The sectional area of the fibers has essentially straight side portions that extend outwardly and are terminated in a convex tip, the so called fingers. Generally, the fingers are positioned unsymmetrically to the each of the central axes. The fingers can be tapered inwardly, from wide to narrow, moving away from the central axis in the direction of the convex tip, or the finger can be tapered outwardly, from narrow to wide narrow, moving away from the central axis in the direction of the convex tip.

The polymeric fibers according to the invention comprise an at least six-fingered sectional area, preferably a six- to ten-fingered sectional area, more preferably a six-fingered sectional area.

In a preferred embodiment, the at least six-fingered sectional area, preferably the six- to ten-fingered sectional area, of the polymeric fiber comprises at least one finger which has a distance from the finger tip to the center of the maximum circle that fits completely in the cross sectional area of the fiber (inner circle rᵢ) that is different from at least one other finger.

Preferably, the at least six-fingered sectional area, preferably the six- to ten-fingered sectional area, comprises an inner circle rᵢ, which is in the range of from 5 μm to 50 μm, more preferably from 10 μm to 30 μm.

Preferably, the at least six-fingered sectional area, preferably the six- to ten-fingered sectional area, comprises an outer circle rₒ (the minimum circle that completely surrounds the cross sectional area of the fiber) which is in the range of from 10 μm to 10 μm, more preferably from 15 μm to 50 μm.

In a preferred embodiment, the ratio of rₒ: rᵢ is in the range of from 3 to 1.01, preferably from 1.5 to 1.01, especially 1.5 to 1.25.

The length of the fingers, that means the distance from the finger tip to the center of the inner circle rᵢ is preferably at least 5 μm to 100 μm, more preferably from 10 μm to 50 μm.

The width of the fingers at the widest point of the finger is preferably at least 5 μm to 100 μm, more preferably from 10 μm to 50 μm.

Each axe of the finger is angularly spaced from the closest axe of the finger, wherein the angle between the axis of each finger is a random distribution from 1° to 170°.

A special feature of the fingers of the fibers is the ratio of the shortest and the longest finger. Therefore, polymeric fibers according to the invention, wherein the ratio of the distance from the finger tip to the center of the inner circle rᵢ of the shortest and the longest finger is in the range of 25:100 to 60:100, are preferred.

The titer of the fibers can be measured in terms of linear mass density, i.e. the weight of a given length of fiber. It is preferred that the polymeric fibers according to the invention have a titer in the range of from 5 to 14 dtex (SI-unit: 1 dtex=1 g/10000 m).

Generally, a spinneret is a type of die principally used in fiber manufacture. It is usually a metal plate with many small holes through which a melt is pulled and/or forced. They enable extrusion of filaments of one denier or less. Conventional spinneret orifices are circular and produce a fiber that is round in cross section. They can contain plethora small holes e.g. from about 50 to 110 very small holes. A special characteristic of their design is that the melt in a discharge section of a relatively small area is distributed to a large circle of spinnerets. Because of the smaller distance in the entry region of the distributor, dead spaces are avoided, and the greater distance between the exit orifices makes for easier threading.

The polymeric fiber according to the invention is prepared by melt or solution spinning through spinneret orifices. For melt spinning, a polymer in the molten state can be fed to a spinneret plate, e.g. by means of an extruder. Preferably, one single fiber is formed by 6 to 10 slots, in particular 6 slots, in the spinneret, wherein the slots are not connected. Thus, one single fiber is formed by the combined plasticized polymer melt exiting the six to ten, in particular six, slots. In other words, the shape of the fiber is formed by six to ten, in particular six, pieces of slots wherein the orifices have an oval shape. By dividing the polymer melt into six to ten, in particular six, partial strands a fiber according to the invention can be achieved. Preferably, an air flow is injected from three to ten, in particular three, four, five or six, gaps of each side forming the fiber shape. In particular, each slot of the six to ten, in particular six, slots forming one fiber has a shape that resembles an oval. Preferably, the length of the oval of each slot is in the range of 0.40 mm to 0.60 mm. Preferably, the width of each oval is in the range of 0.10 mm to 0.15 mm. The six to ten, in particular six, oval slots are irregularly arranged around an imaginary center. The distance of a slot from the imaginary center is from 0.2 mm to 0.4 mm.

Preferably, in the process of the invention the fibers exiting the spinneret are subjected to a one step drawing process. For the drawing process, e.g. the newly formed fibers exiting the orifices of the spinneret are first passed through a heated zone, where such a temperature is set as can lead to plastic deformation of the fibers. Subsequent to the heated zone there can be a cooling zone. In this zone the temperature of the fibers is lowered to below the glass transition temperature Tg. Cooling can be carried out in various ways known to the skilled person. When the fiber bundle leaves the cooling zone, the bundle's temperature should be low enough that it can be passed over or along rotating or static guiding elements without the fibers or the bundle being permanently deformed. For drawing, the speed of the fibers (the spinning speed) exiting the spinneret orifices and, if present, the heating and the cooling zone is fixed. The speed can be set to a certain value e.g. by passing the fiber bundle several times across one or more godets. The godets can be heated if desired.

In the one-step drawing process according to the invention the fibers (i.e. the as-spun product) are drawn immediately after the spinning speed has been fixed.

It was found that if the fibers are drawn in one step, a solid polymeric fiber according to the invention with improved design and improved application properties are obtained.

### MATERIAL OF THE FIBERS

In principle, the polymeric fibers according to the invention may be formed from any fiber-forming polymers, i.e. polymers that can be converted into a melt or solution that satisfies the conditions of spinnability.

Thermoplastic polymeric materials may be used in the present invention. In the sense of the invention thermoplastic polymers are those which can be reversibly deformed above a certain temperature, whereby this process can be repeated as often as desired. Below this specific temperature, these are non-deformable substances. The thermoplastic polymeric material must have rheological characteristics suitable for melt spinning. The molecular weight of the polymer must be sufficient to enable entanglement between polymer molecules and yet low enough to be melt spinnable. For melt spinning, thermoplastic polymers having molecular weights below about 1,000,000 g/mol, preferably from about 5,000 g/mol to about 750,000 g/mol, more preferably from about 10,000 g/mol to about 500,000 g/mol and even more preferably from about 50,000 g/mol to about 400,000 g/mol. The thermoplastic polymeric materials must be able to solidify relatively rapidly, preferably under extensional flow, and form a thermally stable fiber structure, as typically encountered in known processes, such as a spin draw process for staple fibers or a spunbond continuous fiber process. Preferred polymeric materials include, but are not limited to, polyesters, polyolefines, polyamides, polylactates, halogen-containing polymers, polyacrylates, polyvinyl acetates, polyvinyl alcohols, polycarbonates, polyurethanes, polystyrenes, polyphenylene sulfides, polysulfones, polyoxymethylenes, polyimides copolymers derived thereof and mixtures thereof.

Suitable polyolefins are selected from polyethylene, polypropylene, poly(1-butene), polyisobutylene, poly(1-pentene), poly(4-methylpent-1-ene), polybutadiene, polyisoprene and polyolefin containing blends. Suitable polyethylenes are selected from HDPE, LDPE, LLDPE, VLDPE; ULDPE and UHMW-PE. Suitable polyolefin blends comprise at least one polyolefin, especially polyethylene, polypropylene or ethylene-propylene-copolymers and at least one different polymer. The different polymer is e.g. selected from graft or copolymers made of polyolefins and α,β-unsaturated carboxylic acids or carboxylic acid anhydrides, polyesters, polycarbonates, polysulfones, polyphenylene sulfides, polystyrenes, polyamides or a mixture of two or more of the mentioned different polymers.

Suitable halogen-containing fiber-forming polymers are polyvinylchloride (PVC), polyvinylidene chloride (PVDC), polyvinylidene fluoride (PVDF) and polytetrafluoroethylene (PTFE).

The polymeric fibers according to the invention may also comprise or consist of at least one non-thermoplastic polymeric material. Suitable non-thermoplastic polymeric materials are regenerated cellulose (in particular viscose rayon, lyocell), cotton, wood pulp, etc. and mixtures thereof. The polymeric fibers from non-thermoplastic polymeric material may be produced e.g. by solution or solvent spinning. Regenerated cellulose can be produced by extrusion through capillaries into an acid coagulation bath.

In particular, the polymer fibers according to the invention comprise a polymer selected from polyolefins, polyesters, polyamides and copolymers and mixtures thereof.

The polymeric fibers according to the invention can be constructed as mono- or multicomponent filaments. A suitable embodiment is a multi-component filament having a polyester, in particular a polyethylene terephthalate, as core material and a co-polyester as finger material.

The polymeric fibers according to the invention are suitable for the formation of fabrics, e.g. non-wovens that can be advantageously used as filters. The filter substrates may consist of single type of filaments or a combination of different type of filaments.

The polymeric fibers according to the invention are suitable for the formation of fabrics, e.g. nonwovens that can be advantageously used as carpet tiles. The carpet tile substrates may consist of single type of filaments or a combination of different type of filaments.

Different types of filaments can be produced in one step by so called multi-shape spinning by using a spinneret with a combination of orifices having different shapes. Thereby, it is possible to produce multi-layers fabric in one steps. Thus, it is possible to produce filters with different layers, e.g. having a different air permeability. For example, the resulting filter can consist of layers which indirection of the air stream have a gradient from higher to lower air permeability. The invention allows the production of filters that are effective at removing airborne particles and are characterized by a low pressure drop which is retained over long time of application.

The design of the filaments and the resulting filters can be optimized according to the demanded air flow/air penetration.

It is possible to combine fibers of different shapes and/or different sizes and/or different materials: e.g.

Combination of filaments having the same shape but a different denier value (e.g. 12 and 6 denier), e.g. 6 fingers filaments according to the invention in a top-down arrangement.

Combination of filaments having different shapes, e.g. round fibers and 6 fingers fibers according to the invention in a top-down arrangement (two layer fabric).

Combination of filaments having different shapes, e.g. round fibers and 6 fingers fibers according to the invention and round fibers in a top-down arrangement (three layer fabric).

Combination of filaments having different shapes, e.g. 6 fingers fibers according to the invention and round fibers and 6 fingers fibers according to the invention (three layer fabric).

Combination of filaments having different shapes, e.g. 6 fingers fibers according to the invention and shapes selected from triangles, 4-, 5-, 6-, 7-, 8-pointed stars, ellipse, H-shape, double H-shape and combinations thereof in a top-down arrangement (two and multi-layer fabric).

Combination of filaments having different materials, e.g. combinations comprising PET and at least one different polymer, in particular PET/PP or PET/PBT.

### PROCESS

The polymeric fibers according to the invention in one embodiment are spunmelt fibers. Melt-spinning in the sense of the invention is a kind of thermoplastic extrusion. Melt-spinning includes spunlaid processes, meltblown processes and spunbond processes. Those processes are known to a person skilled in the art.

The first step in producing a fiber is usually a compounding or mixing step. In the compounding step, the raw materials are heated, typically under shear. The shearing in the presence of heat will result in a homogeneous melt of the thermoplastic material and optional non-thermoplastic material. The obtained melt is then placed in an extruder, where the material is mixed and conveyed through capillaries to form fibers. The fibers are then attenuated and collected. The fibers are preferably substantially continuous (i.e., having a length to diameter ratio greater than about 2500:1), and will be referred to as spunlaid fibers.

In a preferred embodiment of the process according to the invention, a spinneret is used comprising capillary spinneret orifices forming a pattern of arranged holes designed to provide polymeric fibers as defined above.

The spinneret comprising a pattern of arranged holes designed to provide polymeric fibers as defined above is also one aspect of the invention.

In a preferred embodiment the spinneret comprises orifices consisting of six to ten, preferably six, slots, wherein each slot has a shape that resembles an oval, preferably wherein each oval has a width from 0.10 mm to 0.15 mm and a length from 0.40 mm to 0.60 mm.

The fibers may be converted to fabrics by different bonding methods. In a spunbond or meltblown process, the fibers are consolidated using known industry standard technologies. Typical bonding methods include, but are not limited to, calender (pressure and heat), thru-air heat, mechanical entanglement, hydraulic entanglement, needle punching, and chemical bonding and/or resin bonding. For the pressurized heat and thru-air heat bonding methods fibers are required that are thermally bondable. The fibers may also be woven together to form sheets of fabric. This bonding technique is a method of mechanical interlocking. The fibrous fabric may then be incorporated into an article.

Another aspect of the invention is a textile structure, e.g. in the form of woven fabric, knitted fabric, laid scrim, or nonwoven fabric, comprising the polymeric fibers according to the invention. A textile structure in the sense of invention is a combination of fibers or fiber bundles. It can be single or multi-layered. A textile structure in the context of the present invention is defined as woven fabric consisting of at least one layer, preferably more than one layer, single- or multi-layered woven fabric, single- or multi-layered nonwoven fabric single- or multi-layered knitted fabrics, single- or multi-layered laid scrim fabrics, preferably several layers, consisting of parallel fibres, fibre bundles, yarns, twists or ropes, whereby the individual layers of the parallel fibres or fibre bundles of yarns, twists or ropes may be twisted relative to one another, or nonwovens.

A particular aspect of the invention is a nonwoven fabric comprising the polymeric fibers according to the invention. Therefore, a further aspect of the invention is the use of the polymeric fibers as defined above for the preparation of a nonwoven fabric.

Preferably, the nonwoven fabric of the present invention comprises a tuft-backing containing the polymeric fibers according to the invention.

Products comprising or consisting of the polymeric fibers of the invention are preferably used in filters, in particular filters for air, oil and water; vacuum cleaner filters; furnace filters; face masks; coffee filters, etc.

Products comprising or consisting of the polymeric fibers of the invention may further be used for thermal insulation materials and sound insulation materials. They can be employed in nonwovens for one-time use sanitary products, such as diapers, feminine pads and incontinence articles; biodegradable textile fabrics for improved moisture absorption and softness of wear, such as micro fiber or breathable fabrics; structured webs for collecting and removing dust; reinforcements and webs for hard grades of paper, such as wrapping paper, writing paper, newsprint, corrugated paper board, and webs for tissue grades of paper, such as toilet paper, paper towels, napkins and facial tissues. Products comprising or consisting of the polymeric fibers of the invention may further be employed for medical uses, such as surgical drapes, wound dressing, bandages, dermal patches and self-dissolving sutures and dental uses, such as dental floss and toothbrush bristles. Products comprising or consisting of the polymeric fibers of the invention may further be used for products that absorb water and oil and may find use in oil or water spill clean-up or controlled water retention and release for agricultural or horticultural applications. The resultant fibers or fiber webs may also be incorporated into other materials, such as concrete, plastics, wood pulp, etc. to form composite materials, which can be used as building materials, such as walls, support beams, pressed boards, dry walls and backings, and ceiling tiles.

A further aspect of the invention is the use of the polymeric fibers as defined above for the preparation of a nonwoven fabric.

In one preferred embodiment, the polymeric fibers as defined above can be used for filters and carpets, in particular carpet tiles, wall-to-wall carpets, door mats, throw-in mats, shoe carpets etc. wherein automotive tuft carpets are preferred.

In the tuft-backing layers of fibers according to the invention are in contact with the pile yarn and fix them to the substrate (tuft backing). It is advantageous of the invention that the contact area between the fibers and the pile yarn is significantly higher than with common round fibers known from prior art.

It is possible to arrange the fibers according to the invention in the tuft backing that the contact angle between the fiber and the yarn loop (pile yarn) is preferably 20 to 90°, in particular 40 to 90°, especially 60 to 90°.

A special embodiment of the invention is the use of the polymeric fiber according to the invention as carpet backing and filter.

A further special embodiment of the invention is a polymer fiber composition comprising at least two different polymer fibers, wherein at least one of the fibers is a polymeric fiber as defined above, comprising an at least six-fingered sectional area, preferably six- to ten-fingered sectional area. The afore-mentioned definitions of suitable and preferred fibers comprising an at least six-fingered sectional area are fully referred to here.

The at least two different polymer fibers differ in at least one of the following properties:

shape of the sectional area,

titer of the fibers,

chemical composition of the fibers.

Preferred are multi-titer, single shape filaments or multi shape filaments.

In a preferred embodiment, the at least two different polymer fibers are prepared in a single-stage process, in particular using one single spinneret.

A further embodiment of the invention is a fiber composition comprising at least one of the polymeric fiber according to the invention and defined above and at least one of the fiber which is selected from:

fibers having different denier values compared to the polymeric fiber according to the invention and defined above in a top-down arrangement, fibers having different shapes compared to the polymeric fiber according to the invention and defined above in a top-down arrangement.

The invention is described in more detail in the following examples.

### EXAMPLES

### Example 1

A polyester spunbound fabric having two layers is produced, wherein both layers comprise six-fingered polymeric fibers according to the invention. A special spinneret is used that contains mixtures of fiber shapes and a metering plate to feed polymers to each orifice. One of the layers comprises multi-component filaments comprising a polyethylene terephthalate core material and fingers of a co-polyester material. The other layer comprises a co-polyester material. The fibers are thermally bonded together using heat and pressure.

The resulting fabric consists of two layers, one with high and the other with low air permability. Air filters comprising this fabric are effective at removing airborne particles and are characterized by a low pressure drop which is retained over long time of application.

### Example 2

A polyester spunbound fabric having three layers is produced, wherein the middle layer comprises six-fingered polymeric fibers according to the invention. The upper layer is formed from solid round fibers. The bottom layer is formed from double-H-shaped fibers, and the middle layer is formed from six-fingered polymeric fibers according to the invention. A special spinneret is used that contains mixtures of fiber shapes and a metering plate to feed polymers to each orifice. The middle layer comprises multi-component filaments comprising a polyethylene terephthalate core material, and fingers of a co-polyester material. The other layers comprise a co-polyester material. The fibers are thermally bonded together using heat and pressure.

The resulting fabric consists of three layers with high, low and extra-low air permability, respectively. Air filters comprising this fabric are effective at removing airborne particles and are characterized by a low pressure drop which is retained over long time of application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A solid polymeric fiber, comprising:
a six- to ten-fingered sectional area comprises fingers having central axes, wherein the fingers are positioned unsymmetrically to each of the central axes, and/or wherein the sectional area of the fiber has no rotational axis.

2. The solid polymeric fiber according to claim 1, wherein the six- to ten-fingered sectional area comprises a six-fingered sectional area.

3. The solid polymeric fiber according to claim 1, wherein at least one finger has a distance from a finger tip to a center of a maximum circle that fits completely in a cross sectional area of the fiber (inner circle rᵢ) that is different from at least one other finger.

4. The solid polymeric fiber according to claim 2, wherein inner circle rᵢ, is from 5 μm to 50 μm.

5. The solid polymeric fiber according to claim 3, wherein a minimum circle that completely surrounds a cross sectional area of the fiber (outer circle rₒ) is from 10 μm to 100 μm.

6. The solid polymeric fiber according to claim 4, wherein a ratio of rₒ: rᵢ, is in a range of from 3 to 1.01.

7. The solid polymeric fiber according to claim 2, wherein a distance from the finger tip to a center of the inner circle rᵢ, is at least 5 μm to 100 μm.

8. The solid polymeric fiber according to claim 1, wherein a ratio of a distance from a finger tip to a center of an inner circle rᵢ, of the shortest and a longest finger is in a range of 25:100 to 60:100.

9. The solid polymeric fiber according to claim 1, wherein the fiber is selected from thermoplastic polymers, polyolefines, polyamides, polylactates, copolymers derived thereof, and mixtures thereof.

10. The solid polymeric fiber according to claim 1, wherein the fiber has a titer in a range of from 5 to 15 dtex.

11. The solid polymeric fiber according to claim 1, wherein the fiber is prepared by melt or solution spinning through a spinneret comprising a pattern of orifices,
wherein one single fiber is formed by passing a polymer melt though an arrangement of six to ten slots,
wherein each slot of the six to ten slots forming one fiber has a shape that resembles an oval.

12. The solid polymeric fiber according to claim 11, wherein fibers exiting the spinneret are subjected to a one step drawing process.

13. A nonwoven fabric, comprising:
the solid polymeric fiber according to claim 1.

14. The nonwoven fabric according to claim 13, further comprising:
a tuft-backing containing the solid polymeric fiber.

15. A filter material, comprising:
the solid polymeric fiber according to claim 1.

16. A method of using the solid polymeric fiber according to claim 1 for preparation of nonwoven fabric.

17. The method according to claim 16, wherein the nonwoven fabric is for use as filters and carpets comprising carpet tiles, wall-to-wall carpets, door mats, throw-in mats, or automotive tuft carpets.

18. The method according to claim 16, further comprising using the solid polymeric fiber as carpet backing.

19. A spinneret, comprising:
capillary spinneret orifices forming a pattern of arranged holes configured to provide the solid polymeric fiber according to claim 1.

20. The spinneret according to claim 19, comprising orifices consisting of six to ten slots, wherein each slot has a shape that resembles an oval.
